(19) United States
(12) Patent Application Publication
(10) Pub. No.: US 2012/0311610 A1
(43) Pub. Date: Dec. 6, 2012

(54) PROCESS-BASED CMPI PROVIDER MANAGEMENT

(75) Inventors: Swapnil D. Joshi, Pune (IN); Imranuddin W. Kazi, Pune (IN); Sameer M. Shaikh, Pune (IN); Sushil H. Sharma, Thane (IN); Peng Zhou, Shanghai (CN)

(73) Assignee: INTERNATIONAL BUSINESS MACHINES CORPORATION, Armonk, NY (US)

(21) Appl. No.: 13/152,101

(22) Filed: Jun. 2, 2011

(51) Int. Cl. G06F 9/46

(52) U.S. Cl. 719/313

(57) ABSTRACT

A primary Common Manageability Programming Interface Provider Adapter (CPA) may provide communication between a Windows Management Instrumentation (WMI) server and a first set of a plurality of Common Manageability Programming Interface (CMPI) providers. The primary CPA may operate in a first operating system space. At least one supplemental CPA may provide communication between the WMI server and a respective second set of the plurality of CMPI providers. The CMPI providers in each respective second set of the plurality of CMPI providers may be different than the CMPI providers in the first set of the plurality of CMPI providers. Each of the at least one supplemental CPA may operate in an operating system space separate from the first operating system space.

### BACKGROUND

The present invention relates to Common Information Management (“CIM”) implementations, and more specifically, to communication between a Windows Management Instrumentation (WMI) server and Common Manageability Programming Interface (CMPI) providers.

The CIM model of software is an open standard that controls how an information technology (IT) environment represents managed elements. CIM is similar to an object-oriented standard for IT environments that assist in managing multiple elements that are not necessarily from the same manufacturer or provider. Multiple parties, such as administrators, can exchange management information using a common interface, as well as actively control the managed objects using the same CIM interface. Use of the common interface reduces the need to utilize expensive conversion operations and complex software.

The CIM standard originates with the Distributed Management Task Force (“DTMF”). This CIM standard is used by a plurality of parties to distribute their own implementation of CIM. The DTMF also promulgates its own CIM implementation, the Web-Based Enterprise Management (“WBEM”). A Common Information Management Object Manager (“CIMOM”) brokers CIM objects between a number of sources and destinations. A CIM object is a representation or model of a managed resource, such as a printer, disk drive, or central processing unit (CPU). CIM objects may be represented internally as C++ classes. The CIMOM transfers information between WBEM clients, the CIM Object Manager Repository, and managed resources.

An example of CIM architecture may include management infrastructure and CIM providers. The management infrastructure may include a CIMOM and a CIMOM object repository. The CIMOM may provide applications with uniform access to management data. CIM providers may function as intermediaries between the CIMOM and managed objects. Managed objects may be any appropriate managed objects or systems, such as computer systems, computer networks, monitors, printers, databases, or the like. The providers may supply the CIMOM with data from managed objects, handle requests on behalf of management applications, and generate event notifications.

When a request is made from a management application for information about one of the managed systems, the CIMOM may retrieves information about a class of providers from the CIM repository and the requested information is returned. Based on the information returned, the CIMOM may secure the information from the CIM repository or from the providers. Several types of providers that can plug into the management infrastructure, such as Class, Instance, and Property providers are defined in CIM implementations. Class providers define a corresponding Management Object, or class, in the CIMOM object repository and identify and populate instances of this class. Instance providers define the instances of a pre-defined Management Object and populate their properties with the values obtained or pertinent to the instances of the corresponding managed objects.

In a CIM or WMI based platform management environment, a Platform Agent (PA) uses CIM and provider modules to provide their functionality to a Management Server, such as an IBM Systems Director™ system or an HP InsightManager™ system. IBM Systems Director™ systems, for example, may use a Platform Agent for managing different brands of hardware (system x/p/z). A provider module may use the CIM infrastructure on Windows and Linux where these providers are loaded and would provide data to the Director. A WMI adapter is required to adapt open CIM providers, like CMPI providers, in a Win32 WMI environment. As a result a WMI adapter serves as the provider container.

### BRIEF SUMMARY

According to one embodiment of the present invention, a primary Common Manageability Programming Interface Provider Adapter (CPA) may provide communication between a Windows Management Instrumentation (WMI) server and a first set of a plurality of Common Manageability Programming Interface (CMPI) providers. The primary CPA may operate in a first operating system space. At least one supplemental CPA may provide communication between the WMI server and a respective second set of the plurality of CMPI providers. The CMPI providers in each respective second set of the plurality of CMPI providers may be different than the CMPI providers in the first set of the plurality of CMPI providers. Each of the at least one supplemental CPA may operate in an operating system space separate from the first operating system space.

According to another embodiment of the present invention, a computer system may include a WMI server, a plurality of CMPI providers, a primary CPA, and at least one supplemental CPA. The primary CPA may provide communication between the WMI server and a first set of the plurality of CMPI providers, with the primary CPA operating in a first operating system space. The at least one supplemental CPA may provide communication between the WMI server and a respective second set of the plurality of CMPI providers. The CMPI providers in each second set of the plurality of CMPI providers may be different than the CMPI providers in the first set of the plurality of CMPI providers. Each supplemental CPA may operate in an operating system space separate from the first operating system space.

According to yet another embodiment of the present invention, a computer program product for providing communication between a WMI server and a plurality of CMPI providers may include at least one computer readable storage medium having computer readable program code embodied therewith. The computer readable program code, when read by a processor, may be configured to provide by a primary CPA, communication between the WMI server and a first set of the plurality of CMPI providers. The program code may be further configured to operate the primary CPA in a first operating system space. The program code may be configured to provide by at least one supplemental CPA communication between the WMI server and a respective second set of the plurality of CMPI providers, with the CMPI providers in each respective second set of the plurality of CMPI providers being different than the CMPI providers in the first set of the plurality of CMPI providers. The program code may be configured to operate each of the at least one supplemental CPA in an operating system space separate from the first operating system space.

### BRIEF DESCRIPTION OF THE SEVERAL VIEWS OF THE DRAWINGS

FIG. 1 is an example of a block diagram of a computer system.

FIG. 2 is a block diagram of an example of a WMI based platform management environment.

FIG. 3 is a flow chart of an example of a method that may be performed in a WMI based platform management environment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

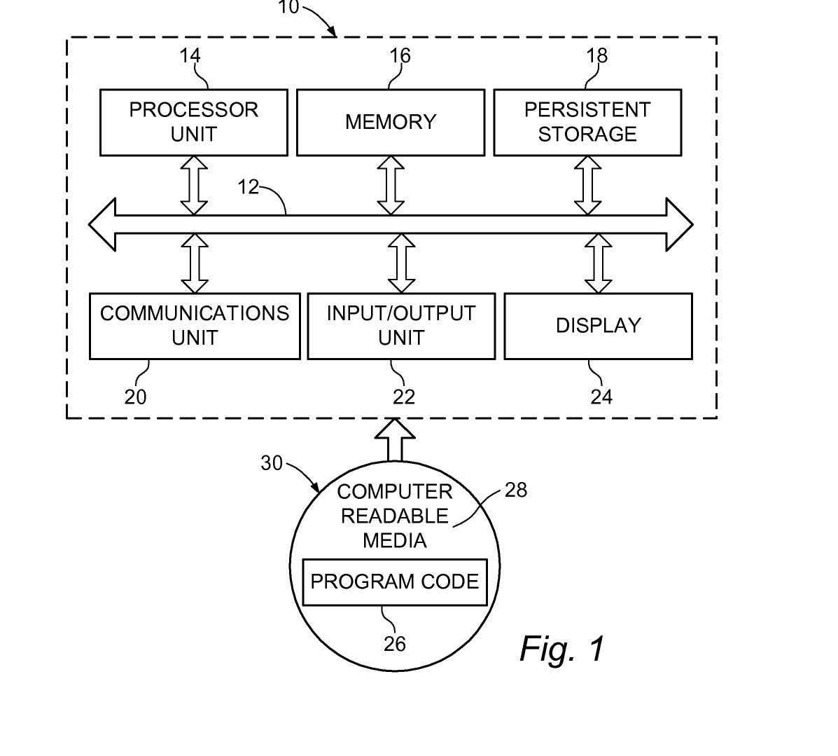

With reference now to FIG. 1, a block diagram of a data processing system is shown in which illustrative embodiments may be implemented. Data processing system 100 is an example of a computer, such as serve, in which computer-usable program code or instructions implementing the processes may be located for the illustrative embodiments. In this illustrative example, data processing system 10 includes communications fabric 12, which provides communication between a processor unit 14, a memory 16, a persistent storage 18, a communications unit 20, an input/output (I/O) unit 22, and a display 24.

Processor unit 14 serves to execute instructions for software that may be loaded into memory 16. Processor unit 14 may be a set of one or more processors or may be a multi-processor core, depending on the particular implementation. Further, processor unit 14 may be implemented using one or more heterogeneous processor systems in which a main processor is present with secondary processors on a single chip. As another illustrative example, processor unit 14 may be a symmetric multi-processor system containing multiple processors of the same type.

Memory 16 and persistent storage 18 are examples of storage devices. A storage device is any piece of hardware that is capable of storing information either on a temporary basis and/or a permanent basis. Memory 16, in these examples, may be, for example, a random access memory or any other suitable volatile or non-volatile storage device. Persistent storage 18 may take various forms depending on the particular implementation. For example, persistent storage 18 may contain one or more components or devices. For example, persistent storage 18 may be a hard drive, a flash memory, a rewritable optical disk, a rewritable magnetic tape, or some combination of the above. The media used by persistent storage 18 also may be removable. For example, a removable hard drive may be used for persistent storage 18.

Communications unit 20, in these examples, provides for communications with other data processing systems or devices. In these examples, communications unit 20 is a network interface card. Communications unit 20 may provide communications through the use of either or both physical and wireless communications links.

Input/output unit 22 may allow for input and output of data with other devices that may be connected to data processing system 10. For example, input/output unit 22 may provide a connection for user input through a keyboard and mouse. Further, input/output unit 22 may send output to a printer. Display 24 may provide a mechanism to display information to a user.

Instructions for the operating system and applications or programs may be located on persistent storage 18. These instructions may be loaded into memory 16 for execution by processor unit 14. The processes of the different embodiments may be performed by processor unit 14 using computer implemented instructions, which may be located in a memory, such as memory 16. These instructions may also be referred to generally as program code 26, including computer-usable program code or computer-readable program code that may be read and executed by a processor in processor unit 14. The program code 26 in different embodiments may be embodied on different physical or tangible computer-readable media, such as memory 16 or persistent storage 18.

In some examples, program code 26 may be located in a functional form on a computer-readable media 28 that may be selectively removable and may be loaded onto or transferred to data processing system 10 for execution by processor unit 14. Program code 26 and computer-readable media 28 may form a computer program product 30 in these examples. In some examples, computer-readable media 28 may be in a tangible form, such as, for example, an optical or magnetic disc that is resident in, or inserted or placed into a drive or other device that is part of persistent storage 18. Program code on computer readable media 28 may be transferred onto a storage device, such as a hard drive that is part of persistent storage 18. In a tangible form, computer-readable media 28 may take the form of a persistent storage, such as a hard drive, a thumb drive, or a flash memory that is connected to data processing system 10. The tangible form of computer-readable media 28 may also be referred to as computer-recordable storage media. In some instances, computer-recordable media 28 may not be removable, such as the media in a hard drive or solid-state memory.

Alternatively, program code 26 may be transferred to data processing system 10 from computer-readable media 28 through a communications link to communications unit 20 and/or through a connection to input/output unit 22. The communications link and/or the connection may be physical or wireless in the illustrative examples. The computer-readable media also may take the form of non-tangible media, such as communications links or wireless transmissions containing the program code. The different components illustrated for data processing system 10 are not meant to provide architectural limitations to the manner in which different embodiments may be implemented. The different illustrative embodiments may be implemented in a data processing system including components in addition to or in place of those illustrated for data processing system 10. Other components shown in FIG. 1 can be varied from the illustrative examples shown. As one example, a storage device in data processing system 10 may be any hardware apparatus that may store data. Memory 16, persistent storage 18, and computer-readable media 28 are examples of storage devices in a tangible form.

In another example, a bus system may be used to implement communications fabric 12 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 16 or a cache such as found in an interface and memory controller hub that maybe present in communications fabric 12.

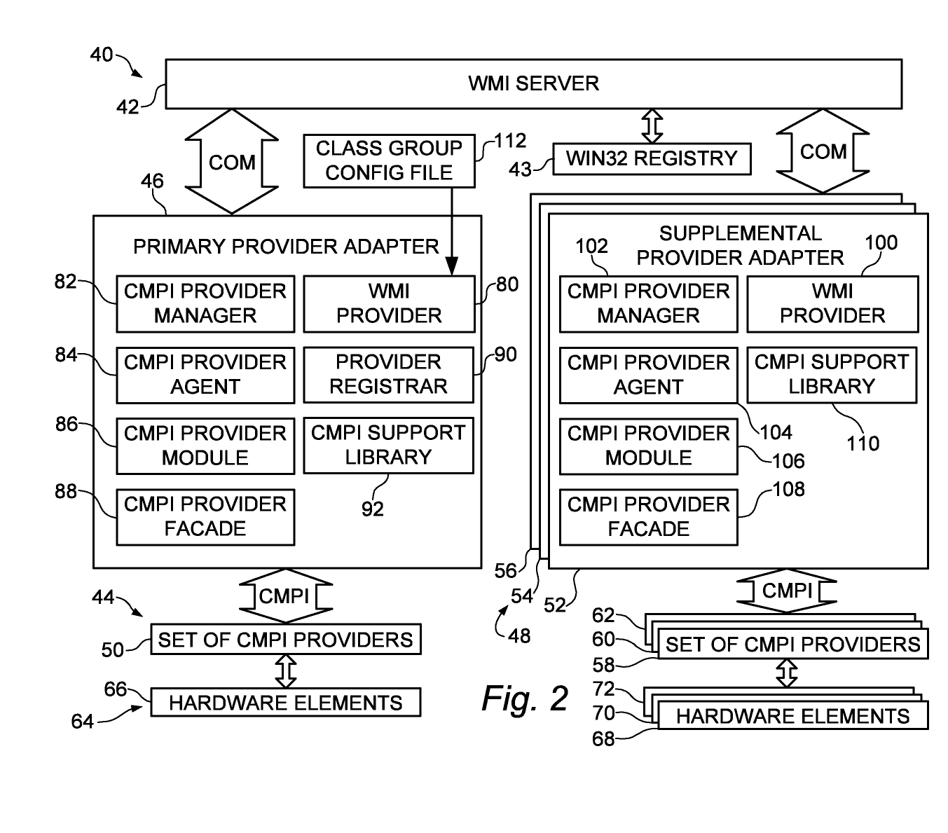

It has been observed that when multiple providers are statically running in a same process space (operating system space) with a provider adapter, a provider is vulnerable to faults by other providers and providers contend for resources such as threads and CPU cycle. Performance may be improved by a CMPI provider management system, such as a processor-based CMPI provider management system 40, an example of which is illustrated in FIG. 2.

Referring now to FIG. 2, an example of a computer system, shown generally at 40, is illustrated for providing communication between a Windows Management Instrumentation (WMI) server 42 and a plurality of Common Manageability Programming Interface (CMPI) providers shown generally at 44. WMI server 42 accesses a Win 32 registry 43 that stores configuration information for component object model (COM) based components. COM is a binary-interface standard for software componens introduced by Microsoft in 1993. It is used to enable interprocess communication and dynamic object creation in a wide range of programming languages.

Computer system 40 may also include a primary CMPI provider adapter (primary CPA) 46, and at least one supplemental CPA shown generally at 48. The primary CPA may provide communication between WMI server 42 and a first set 50 of the plurality of CMPI providers 44. The primary CPA may operate in a first operating system space. Communication with WMI server 42 is provided according to the (COM) standard,

Supplemental CPA's 48 may include a first supplemental CPA 52, and may also include additional supplemental CPA's, such as a second supplemental CPA 54 and a third supplemental CPA 56. Each supplemental CPA may provide communication between the WMI server and a respective second set of the plurality of CMPI providers. For example, supplemental CPAs 52, 54 and 56 may provide communication with respective sets 58, 60, and 62 of CMPI providers. The CMPI providers in each set of CMPI providers may be different. Each supplemental CPA may operate in an operating system space separate from the first operating system space, and each CPA may in fact operating in an operating system space separate from the operating system space of other CPAs. Further, each CPA may operate in an operating system space separate from the operating system space of WMI server 42.

As discussed above, CMPI providers may function as intermediaries between the CPAs and managed objects, illustrated generally in FIG. 2 as hardware elements 64. More specifically, set 50 of CMPI providers may provide data associated with one or more hardware elements 66. Similarly, sets 58, 60, and 62 of CMPI providers may provide data associated with respective sets of hardware elements 68, 70, and 72. Communication with the CPAs may be as COM communication or CMPI communication, depending upon the standards used by the vendors of the respective hardware elements. Hardware elements 64 may be any appropriate managed objects or systems, such as computer systems, computer networks, monitors, printers, databases, or the like. The CMPI providers may supply the associated CPA with data from the hardware elements, handle requests on behalf of WMI management applications, and generate event notifications.

The primary and supplemental CPAs may function as WMI adapters to adapt open CIM providers, like CMPI providers 44, in a Win32 WMI environment. The CPAs, then, as WMI adapters, serve as provider containers.

In this embodiment of this invention, there are two types of provider adapters functioning as COM servers. One is a master or primary CPA 46, which is a unique COM server that provides some common services. The other is sub or supplemental CPAs 48, which are also COM servers. In a further example, CPA contains a separate CIM class or group of providers 44. Primary CPA may be a native WMI provider that provides the common services to the one or more supplemental CPA.

In this example, the primary CPA includes several components, such as a WMI provider 80, a CMPI provider manager 82, a CMPI provider agent 84, a CMPI provider module 86, a CMPI provider facade 88, a provider registrar 90, and a CMPI support library 92.

WMI provider 80 provides communication between primary CPA 46 and WMI server 42. CMPI provider manager 82 may be responsible for managing the cache of various CMPI providers in the system. This facilitates the look up function by providing a single source of information. CMPI provider agent 84 provides a single integrated interface that is a combination of a physical (module) provider and a logical (pointer) provider. The CMPI provider agent may extend CMPI provider facade 88, which protects the layers above this module from badly behaved providers, and to keep track of the states of the providers 44.

CMPI provider module 86 may abstract the physical module or hardware element 66 and any dynamic entry points it may have. Any state information other than that of the library itself may either be handled in CMPI support library 92 or in a higher level object. CMPI support library 92 may be a common library that performs a basic conversion function for CMPI style data types.

The CMPI and COM components do not communicate directly. The COM layer is used to interact with WMI layer. This interaction is done with the WMI class of providers. WMI COM data may be converted to CMPI data by a WMI common linkage class of providers. Hence, WMI server 42 may communicate with the primary CPA or supplemental CPA, as the case may be, using the COM format. The primary or supplemental CPA then may call internal functions, which convert the data provided in COM format to CMPI standard format. This CMPI data may then be passed over to the CMPI style provider agents and vice versa.

Supplemental CPAs 48 may be simplified versions of primary CPA 46. That is, supplemental CPAs 48 may include a WMI provider 100, a CMPI provider manager 102, a CMPI provider agent 104, a CMPI provider module 106, a CMPI provider façade 108, and a CMPI support library 110. These components have functions as described for the primary CPA for providing an interface between WMI server 42 and the associated set of CMPI providers 44.

Primary CPA 46 may maintain a global provider module registration table in provider registrar 90, and each supplemental CPA may query the module name and provider name of a given CIM class through a WMI lookup COM inter-face made available by the primary CPA. As an example, the provider module registration table may require about 5 or more megabytes of storage space. Hence, having a single registration table in the provider registrar may reduce the amount of memory required of each supplemental CPA, compared to having a local copy of the registration table in each supplemental CPA.

The primary CPA may contain internal providers, such as CMPI provider agent 84, which hook the operations on provider group (PG) or Class. Primary CPA 46 also may distribute CIM classes through labeling CIM class definitions in a WMI repository within provider registrar 90 with the associated CPA provider name.

Primary CPA 46 may provide a COM server registration service for the supplemental provider adapters 48, such as registering and unregistering the COM server for the supplemental CPA, and creating all necessary CIM instances for each supplemental CPA, like Win32Provider, into the WMI repository. Each supplemental CPA may be a native WMI provider that acts as a bridge to other open providers of a given group. In the case of CMPI providers, the supplemental or primary CPA may translate operations and objects into CMPI terms and route requests and responses between the CIMOM (CPA) and one or more providers. For example, a DCOM request for WMI instance objects to the CPA via the IWbemServices::EnumInstances method may be translated and routed to a provider's implementation of CMPIInstanceMT::enumerateInstances and the resulting CMPIInstance objects may be translated into IWbemObject objects and delivered to WMI server 42.

In some examples, the supplemental CPAs are assigned CMPI providers of a single group or class. In such examples an XML file, called Class Group Configure File, depicts CIM Class Grouping meta-information, which includes CLSID, used for creating the COM server of the primary CPA or supplemental CPA. The primary CPA may link the CIM classes to a target supplemental CPA by changing the CIM standard qualifiers ‘dynamic’ and ‘provider’ on the basis of a class group configure file 112 shown coupled to WMI provider 80 of primary CPA 46 in FIG. 2. The primary CPA may also maintain the CLSID and provider name of the supplemental CPA, and use it to register and un-register the COM server for the given supplemental CPA.

As indicated above, a new supplemental CPA may be created for a new CIM group. This may be accomplished for example in the following steps.

A user may edit property ModuleGroupName of PG_ProviderModule for the given CIM Class in PG_ProviderCapabilties in the registration management object format (MOF) file which links the specified provider or class to the class group. The MOF file format is used to describe CIM objects. Here class group may be moduleName i.e “Name” Property of PG_ProviderModule in absence of ModuleGroupName property.

The user may then run mofcomp to compile the class MOF file, including class schema MOF file and registration MOF file.

The primary CPA 46 may then get the CIM class registration request for above class, read the Class Group Config File, and check if this group is a new group. For a new group. The primary CPA may allocate a unique CLSID using Win32 API ‘CoCreateGuid.’ A new entry may be added in Win32 Registry 43 [HKCR\CLSID\{clsid}], and the value of key ‘localserver32’ may be set as the supplemental CPA with the new CLSID. A new entry may then be made into the group config file to show the existence of the current group. A new entry may also be made into the provider registration table in provider registrar 90 to, and record which provider module this class belongs to. An instance of _Win32Provider, _InstanceProviderRegistration, _MethodProviderRegistration and _EventProviderRegistration may then be created. The CIM class may be labeled by the primary CPA to the target COM server using the CIM standard qualifiers ‘dynamic’ and ‘provider.’

A user may then input a CIM request to the new CIM class. WMI server 42 may then read the CIM class qualifier ‘provider’ and start the COM server of the sub wmicpa in the supplemental CPA. The supplemental CPA may then call the COM interface IWMILookup provided by the primary CPA. The primary CPA may then return the target provider name and module name for the given CIM class by searching the provider registration table in provider registrar 90. The supplemental CPA may then load the necessary stack and provider module to serve this request, and forward the CIM request to the loaded CMPI provider to return the result to WMI server 42. The user then receives the result.

In some embodiments, grouping of CIM classes may be provided by creating one or more supplemental CPAs 48, as described, and ungrouping of CIM classes may be provided by eliminating the supplemental CPAs and using only the primary CPA for all CMPI providers. An indicator accessible to the primary CPA may be used to switch between the group mode, in which each supplemental CPA operates in an operating system space separate from the operating system space of the primary CPA and controls a defined group of providers, and a combined mode in which only one CPA—the primary CPA—operates in a single operating system space and controls all of the providers.

The mode indicator supported by the primary CPA may be an option/flag OOPEnable (Out of Process Enable). When OOPEnable indicates that the Out-of-Process mode is not enabled, the primary CPA performs all the required re-stamping, un-registration/registration of CIM classes and COM servers respectively. The mode indicator may change from an Out-of-Process mode in which CMPI providers are grouped by class and assigned to respective supplemental CPAs, to an In-Processs mode in which the CIM Classes/Providers are ungrouped by grouping them under one COM server, i.e., the primary CPA. Thus, when the mode indicator, OOPEnable, equals false, the primary CPA may iterate through all the PG_ProviderCapabilties i.e. registered CIM Classes and stamp them with the primary CPA name.

Processing may also switch from the In-Process mode to the Out-of-Processs mode, such as when OOPEnable switches from false to true. When OOPEnable =true, the CIM classes and providers may be grouped under different respective COM Server's, i.e., different supplemental CPAs. When OOPEnable=true, the primary CPA may iterate through all the PG_ProviderCapabilties and PG_ProviderModules, i.e., registered CIM Classes and Provider Modules, respectively. A new COM Server and corresponding _Win32 static instances are then created when a new Group is encountered. Finally, the CIM Class is stamped with the supplemental CPA name.

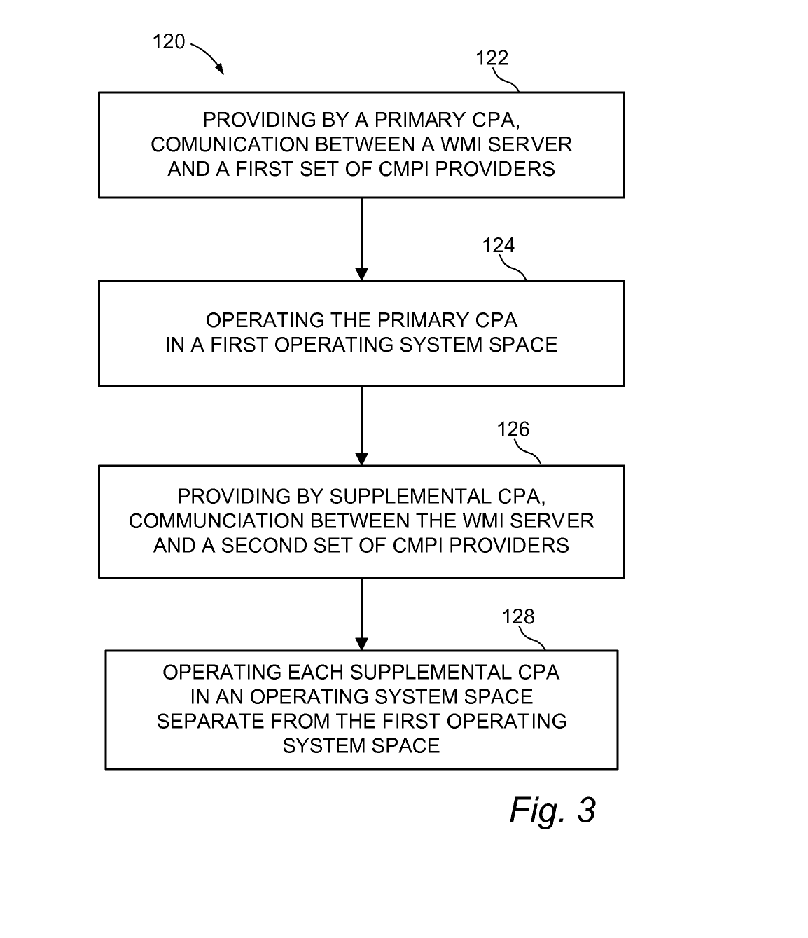

It is then seen that in this example, this process may dynamically create an out-of-process COM server or supplemental CPA operating in a different operating systems space from the operating space of the primary CPA. As shown in FIG. 3, a method 120 may include providing at 122 by a primary CPA, communication between a WMI server and a first set of CMPI providers. At 124, the primary CPA may operate in a first operating system space. A supplemental CPA may communicate between the WMI server and a second set of CMPI providers, as shown at 126. At 128, each supplemental CPA may operate in an operating system space separate from the first operating system space.

In some examples, the primary CPA may provide a provider registration table, and register in the provider registration table the CMPI providers in each respective second set of the plurality of CMPI providers. A WMI-provider agent of the supplemental CPA may provide communication with the WMI server, and a CMPI-provider agent of the supplemental CPA may provide communication between the WMI-provider agent and each CMPI provider in the second set of CMPI providers.

In some examples, the CMPI providers in the first and second sets may be classified into different groups, and CMPI providers belonging to a single group may be assigned to the second set of the plurality of CMPI providers. In some examples, a plurality of supplemental CPAs may provide communication with respective sets of the plurality of CMPI providers belonging to different groups. Further, the primary CPA may receive information associated with a new CMPI provider to be added to the plurality of CMPI providers, the new CMPI provider belonging to a given group. A determination may be made as to whether a supplemental CPA provides communication with CMPI providers belonging to the given group, and if there is no supplemental CPA providing communication with CMPI providers belong to the given group, creating a new supplemental CPA for providing communication with CMPI providers belonging to the given group. The new CMPI provider may then be assigned to the new supplemental CPA.

In some examples, the primary CPA may determine according to a process-mode indicator whether supplemental CPAs are enabled in an out-of-process mode or disabled in an in-process mode. The at least one supplemental CPA may be created when supplemental CPAs are enabled, and the primary CMPI may provide communication with all CMPI providers without any supplemental CPAs when supplemental CPAs are not enabled. The primary CPA may be further responsive to a change in the process-mode indicator to change operation between the out-of-process mode and the in-process mode.

Such steps may be provided as a method, a system, or a computer program product for providing communication between a WMI server and a plurality of CMPI providers. As discussed with reference to FIG. 1, such a computer program product may comprise at least one computer readable storage medium having computer readable program code embodied therewith, the computer readable program code, when read by a processor, configured to perform the described steps.

A method, system, or computer product as described may provide efficiencies of operation, such as the use of a common provider registrar resident in the primary CPA, in addition to other common services that the primary CPA may provide. For example, where there are many PA SMASH providers and legacy providers in commercial products using CIM runtime, operation of those providers may be isolated so that the impact may be localized when conflicts occur. As a result, the supplemental-CPA-based CIM provider containers may be more stable, since they are loaded into separate processes based on the CIM groups each provider falls into.

This computer-implemented method may enhance the availability of management plug-ins i.e. CMPI providers on Windows operating systems and allow easier debugging and troubleshooting for provider issues. The method may be used to spawn out-of-process COM servers (supplemental CPAs) working as WMI adapter (native WMI Provider) that supports multiple types of CIM providers, like CMPI providers, in Win32 WMI environment. Each WMI adapter may load a group of CIM providers into its process space thereby reducing conflicts that may adversely affect the availability of other providers if loaded in same WMI Adapter process space. Exemplary methods thus may provide for dynamically creating WMI adapters by spawning COM servers, the supplemental CPAs, and linking them to the WMI server. Additionally, separating common provider registration services into a standalone COM server, the primary CPA, may decrease the memory requirement of the system.

Studies indicate that examples of this general method may provide improved CPU performance without obvious memory footprint degradation compared to operating the providers in a common operating system space (an in-process mode). Performance improvements may result from the supplemental CPA getting requests directly from the WMI server and send responses directly back to the WMI server. There may be extra performance overhead due to additional processing for marshalling and demarshalling COM Interfaces and associate PIPE communications. Each supplemental CPA may have a reduced memory foot print as compared to primary CPA. The supplemental CPA life cycle may be taken care of by the WMI server as the primary CPA may register the supplemental CPA dynamically with the WMI server and does not need to manage it. Further, the newly created agent life cycle may be maintained and managed by writing the code similar to the code for the WMI server. This may introduce redundancy as well as extend the life cycle, resulting in improved stability.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
providing by a primary Common Manageability Programming Interface Provider Adapter (CPA), communication between a Windows Management Instrumentation (WMI) server and a first set of a plurality of Common Manageability Programming Interface (CMPI) providers;
operating the primary CPA in a first operating system space;
providing by at least one supplemental CPA communication between the WMI server and a respective second set of the plurality of CMPI providers, the CMPI providers in each respective second set of the plurality of CMPI providers being different than the CMPI providers in the first set of the plurality of CMPI providers; and
operating each of the at least one supplemental CPA in an operating system space separate from the first operating system space.

2. The method of claim 1, further comprising maintaining by the primary CPA a provider registration table, and registering in the provider registration table the CMPI providers in each respective second set of the plurality of CMPI providers.

3. The method of claim 2, wherein providing by at least a supplemental CPA communication between the WMI server and a second set of the plurality of CMPI providers includes communicating by a WMI-provider agent of the supplemental CPA with the WMI server, and providing by a CMPI-provider agent of the supplemental CPA communication between the WMI-provider agent and each CMPI provider in the second set of CMPI providers.

4. The method of claim 1, wherein the CMPI providers in the first and second sets are classified into different groups, the method further comprising assigning CMPI providers belonging to a single group to the second set of the plurality of CMPI providers.

5. The method of claim 4, wherein providing by at least a supplemental CPA communication between the WMI server and a second set of the plurality of CMPI providers includes providing by a plurality of supplemental CPAs communication with respective sets of the plurality of CMPI providers belonging to different groups.

6. The method of claim 5, further comprising receiving by the primary CPA information associated with a new CMPI provider to be added to the plurality of CMPI providers, the new CMPI provider belonging to a given group, determining whether a supplemental CPA provides communication with CMPI providers belonging to the given group, and if there is no supplemental CPA providing communication with CMPI providers belong to the given group creating a new supplemental CPA for providing communication with CMPI providers belonging to the given group, and assigning the new CMPI provider to the new supplemental CPA.

7. The method of claim 1, further comprising determining by the primary CPA according to a process-mode indicator whether supplemental CPAs are enabled in an out-of-process mode or disabled in an in-process mode, and creating the at least one supplemental CPA when supplemental CPAs are enabled, and providing by the primary CMPI communication with all CMPI providers without any supplemental CPAs when supplemental CPAs are not enabled.

8. The method of claim 7, wherein the primary CPA is further responsive to a change in the process-mode indicator to change operation between the out-of-process mode and the in-process mode.

9. A computer system comprising:
a WMI server;
a plurality of CMPI providers;
a primary CPA providing communication between the WMI server and a first set of the plurality of CMPI providers, the primary CPA operating in a first operating system space; and
at least one supplemental CPA providing communication between the WMI server and a respective second set of the plurality of CMPI providers, the CMPI providers in each second set of the plurality of CMPI providers being different than the CMPI providers in the first set of the plurality of CMPI providers, and each supplemental CPA operating in an operating system space separate from the first operating system space.

10. The computer system of claim 9, further comprising a provider registration table, and wherein the primary CPA maintains a registry of the CMPI providers in the provider registration table.

11. The computer system of claim 9, wherein the supplemental CPA further includes a WMI-provider agent for communicating with the WMI server, and a CMPI-provider agent for communicating between the WMI-provider agent and each CMPI provider in the second set of CMPI providers.

12. The computer system of claim 9, wherein the plurality of CMPI providers are classified into different groups, and the second set of the plurality of CMPI providers belong to a single group.

13. The computer system of claim 12, wherein the at least one supplemental CPA includes a plurality of supplemental CPAs for providing communication with respective sets of the plurality of CMPI providers belonging to different groups.

14. The computer system of claim 13, wherein the primary CPA is configured to receive information associated with a new CMPI provider added to the plurality of CMPI providers, the new CMPI provider belonging to a given group, determine whether a supplemental CPA provides communication with CMPI providers belonging to the given group, and if there is no supplemental CPA providing communication with CMPI providers belonging to the given group, creating a new supplemental CPA for providing communication with CMPI providers belonging to the given group, and assigning the new CMPI provider to the new supplemental CPA.

15. The computer system of claim 9, wherein the primary CPA is responsive to a process-mode indicator indicating whether out-of-process CIM servers are enabled or disabled, and is further configured to switch between an out-of-process mode in which the at least one supplemental CPA is created, and an in-process mode in which the primary CPA provides communication with all CMPI providers and no supplemental CPA exists.

16. The computer system of claim 15, wherein the primary CPA is further responsive to a change in the process-mode indicator to change operation between the out-of-process mode and the in-process mode.

17. A computer program product for providing communication between a WMI server and a plurality of CMPI providers, the computer program product comprising:
at least one computer readable storage medium having computer readable program code embodied therewith, the computer readable program code, when read by a processor, configured to:
provide by a primary CPA, communication between the WMI server and a first set of the plurality of CMPI providers,
operate the primary CPA in a first operating system space;
provide by at least one supplemental CPA communication between the WMI server and a respective second set of the plurality of CMPI providers, the CMPI providers in each respective second set of the plurality of CMPI providers being different than the CMPI providers in the first set of the plurality of CMPI providers; and
operate each of the at least one supplemental CPA in an operating system space separate from the first operating system space.

18. The computer program product of claim 17 wherein the computer readable program code, when read by a processor, is further configured to maintain by the primary CPA a provider registration table, and register in the provider registration table the CMPI providers in each respective second set of the plurality of CMPI providers.

19. The computer program product of claim 17 wherein the CMPI providers in the first and second sets are classified into different groups, and the computer readable program code, when read by a processor, is further configured to assign CMPI providers belonging to a single group to the second set of the plurality of CMPI providers.

20. The computer program product of claim 17 wherein the computer readable program code, when read by a processor, is further configured to determine by the primary CPA according to a process-mode indicator whether supplemental CPAs are enabled or disabled, and create the at least one supplemental CPA when supplemental CPAs are enabled, and provide by the primary CMPI communication with all CMPI providers without any supplemental CPAs when supplemental CPAs are not enabled.
